(19) United States
(12) Patent Application Publication
(10) Pub. No.: US 2026/0219810 A1
(43) Pub. Date: Jul. 30, 2026

(54) IMAGE FORMING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: HIROSHI OYA, Tokyo (JP)

(21) Appl. No.: 19/436,438

(22) Filed: Dec. 30, 2025

(30) Foreign Application Priority Data
Jan. 24, 2025 (JP) 2025-010495

(51) Int. Cl. G06F 3/12

(52) U.S. Cl. CPC G06F 3/1204; G06F 3/1221; G06F 3/1225; G06F 3/123; G06F 3/1238; G06F 3/1279

(57) ABSTRACT

An image forming apparatus that can quickly display a screen of an application on activation and resume when the application is temporarily stopped or uninstalled. A function is added to the image forming apparatus by additionally installing an external application. The image forming apparatus includes a memory device and a processor to stop the external application when the external application is started and a stop instruction to the external application is received from a user, and change a screen setting displayed on activation or resume in accordance with a change instruction from the user to change the screen setting displayed on the activation or the resume when the stop instruction and the change instruction are received under a state where a screen setting of the external application is set as the screen setting displayed on the activation or the resume in device setting information about the image forming apparatus.

### BACKGROUND

### Field of the Technology

The aspect of the embodiments relates to an image forming apparatus on which an external application is additionally installed, a control method therefor, and a storage medium storing a control program therefor.

### Description of the Related Art

An image forming apparatus (a multifunction peripheral) having a plurality of functions such as printing, scanning, and faxing, can display various screens on a display unit. There is a known technique that sets a screen of a function frequently used by a user so as to be displayed at activation (power on), at resume from a power saving state, or the like. Hereinafter, this setting is referred to as a “screen setting displayed on activation/resume”.

In the meantime, it is known that various functions can be added to the image forming apparatus by additionally installing external applications having related functions. An additionally installed application is activated by selecting a button or an icon on a screen added at the installation, and the screen can transition to a screen of the selected application. The application may be started when the image forming apparatus is powered on, or whether to start the application when the image forming apparatus is powered on may be set in the application. Such a setting and a technique to change the setting at uninstallation of an application have been proposed (for example, see Japanese Patent Laid-Open No. 2006-311590).

Further, there is also known an image forming apparatus that enables a screen of an additionally installed application to be set to the “screen setting displayed on activation/resume”.

However, there is a case where the additionally installed application is desired to be invalidated by temporary stop or uninstallation. For example, there is a case where an authentication device (an IC card reader, a vein authentication device, or the like) to performing authentication by a user authentication application fails, a case where a license of the application is expired, or the like.

In such a case, the application can be temporarily stopped. However, if the screen of the temporarily stopped application is registered as the “screen setting displayed on activation/resume”, the user needs to remember the registration and change the setting. If the setting is not changed, a screen not desired by the user may be displayed on activation or resume, or it may take time to display the screen, which may cause inconvenience for the user. The same inconvenience occurs when an application is uninstalled.

### SUMMARY

The present disclosure provides an image forming apparatus that can quickly display a screen of an application on activation and resume when the application is temporarily stopped or uninstalled, a control method therefor, and a storage medium storing a control program therefor.

Accordingly, an aspect of the embodiments provides an image forming apparatus to which a function is added by additionally installing an external application, the image forming apparatus including a memory device that stores a set of instructions, and at least one processor that executes the set of instructions to stop an operation of the external application in a case where the external application is in a started state and a stop instruction to stop the external application is received from a user, and change a screen setting displayed on activation or resume from a power saving state in accordance with a change instruction from the user to change the screen setting displayed on the activation or the resume in a case where the stop instruction and the change instruction are received under a state where a screen setting of the external application is set as the screen setting displayed on the activation or the resume.

Features of the present disclosure will become apparent from the following description of embodiments with reference to the attached drawings. The following description of embodiments is described by way of example.

### BRIEF DESCRIPTION OF THE DRAWINGS

FIG. 1 is a view illustrating a network configuration of an information processing system of a first embodiment.

FIG. 2 is a block diagram illustrating a hardware configuration of an image forming apparatus in FIG. 1.

FIG. 3 is a block diagram illustrating a hardware configuration of an information processing apparatus in FIG. 1.

FIG. 4 is a sequence chart illustrating a sequence of a control process executed when an application pause button is pressed according to the first embodiment.

FIG. 5 is a table illustrating an example of application management information used in the first embodiment.

FIG. 6A and FIG. 6B are views illustrating examples of application management screens displayed on a display unit of the information processing apparatus of the first embodiment.

FIG. 7A and FIG. 7B are views illustrating examples of device setting change confirmation screens displayed according to the first embodiment.

FIG. 8 is a view illustrating an example of a setting screen 800 for setting a screen displayed on activation/resume according to the first embodiment.

FIG. 9A, FIG. 9B, and FIG. 9C are tables illustrating examples of the device setting information according to the first embodiment.

FIG. 10 is a sequence chart illustrating a sequence of a control process executed when an application pause button is pressed and when an application start button is pressed according to a second embodiment.

FIG. 11 is a view illustrating an example of a device setting change confirmation screen according to the second embodiment.

FIG. 12 is a view illustrating an example of an advanced setting screen of the “screen setting displayed on activation/resume” according to the first embodiment.

### DESCRIPTION OF THE EMBODIMENTS

Hereinafter, embodiments of the present disclosure will be described in detail with reference to the drawings. The following embodiments do not limit the disclosure according to the scope of the claims, and not all combinations of features described in the embodiments are necessarily essential to the solution of the disclosure.

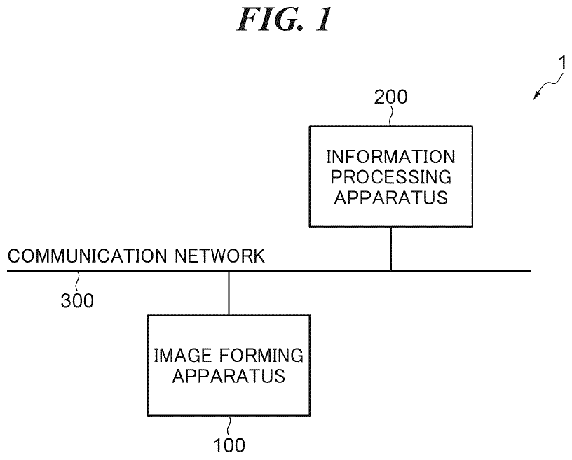

A first embodiment of the present disclosure will be described. FIG. 1 is a view illustrating a network configuration of an information processing system 1 according to the present embodiment.

The information processing system 1 is configured by connecting an image forming apparatus 100 and an information processing apparatus 200 via a communication network 300 such as the Internet.

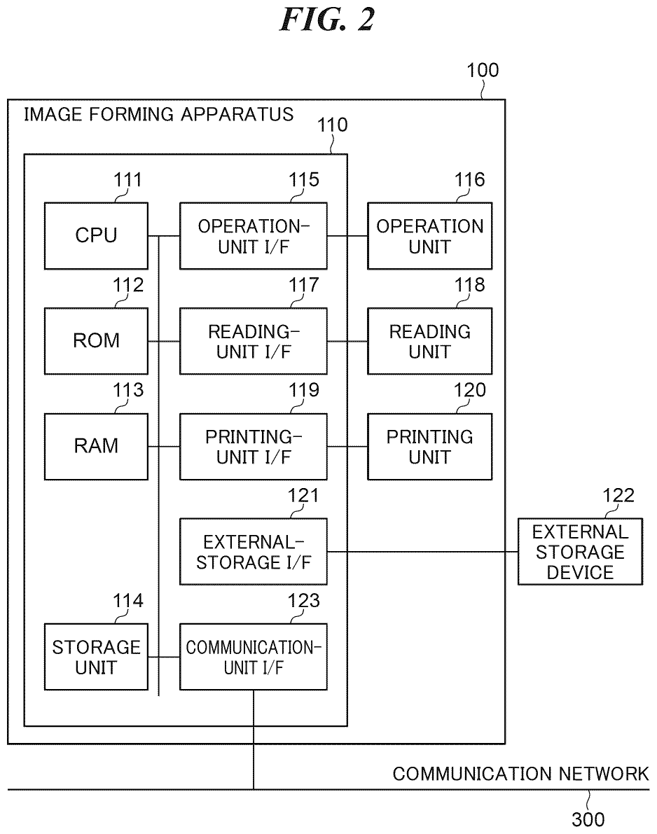

The image forming apparatus 100 records various pieces of setting information in a storage unit 114 of the image forming apparatus 100, which will be described later with reference to FIG. 2, and is controlled according to the various pieces of setting information recorded.

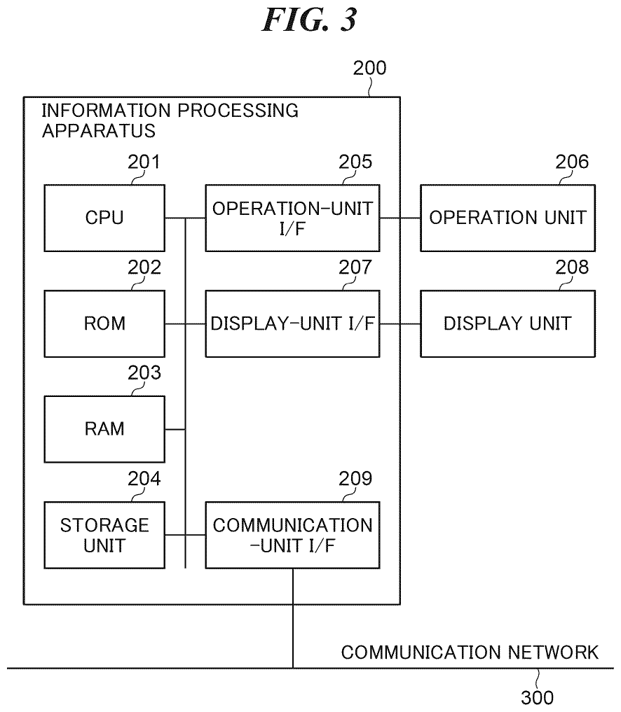

The information processing apparatus 200 requests the image forming apparatus 100 to transmit use status information and various pieces of setting information about the image forming apparatus 100, and receives the use status information and the various pieces of setting information. Then, the information processing apparatus 200 can display the information received from the image forming apparatus 100 in response to this request on a display unit 208, which is described later with reference to FIG. 3. A user can change the settings by using an operation unit 206, which is also described later with reference to FIG. 3.

The communication network 300 may have a network configuration capable of transmitting and receiving various information including image data in the present embodiment. In the present embodiment, the communication network 300 is configured by a wired line, but may be configured to be connected to an access point (not shown) wirelessly, for example.

Communication between the image forming apparatus 100 and the information processing apparatus 200 uses a communication protocol such as the hypertext transfer protocol (hereinafter referred to as HTTP). Because the control method is known, its detailed descriptions are omitted.

FIG. 2 is a block diagram illustrating a hardware configuration of the image forming apparatus 100. As shown in FIG. 2, the image forming apparatus 100 includes a controller 110, an operation unit 116, a reading unit 118, and a printing unit 120.

The controller 110 controls operations of the entire image forming apparatus 100. The controller 110 includes a CPU 111, a ROM 112, a RAM 113, the storage unit 114, an operation-unit I/F 115, a reading-unit I/F 117, a printing-unit I/F 119, and a communication-unit I/F 123, which are communicably connected to each other via a bus.

The CPU 111 reads control programs stored in the ROM 112 or the storage unit 114, and performs various control processes such as a reading process and a printing process. The ROM 112 stores the control programs that are executable by the CPU 111. The ROM 112 also stores a boot program, font data, etc. The RAM 113 is a main storage memory of the CPU 111 and is used as a work area and a temporary storage area onto which the control programs stored in the ROM 112 and the storage unit 114 are developed.

The storage unit 114 stores image data, print data, an address book, various programs, and various setting information. In the present embodiment, a flash memory is assumed as the storage unit 114, but an auxiliary storage unit such as an SSD, an HDD, or an eMMC may be used.

Although the image forming apparatus 100 shall be configured to perform various processes illustrated in flowcharts described later with the CPU 111 using one memory (the RAM 113), another configuration may be employed.

For example, a plurality of CPUs, RAMs, ROMs, and the storage units may cooperate with each other to execute a process illustrated in a sequence chart described later. Further, a part of the process may be executed by using a hardware circuit such as an ASIC or an FPGA.

The operation-unit I/F 115 connects the operation unit 116 to the controller 110. The operation unit 116 displays information to a user and detects an input from the user.

The reading-unit I/F 117 connects the reading unit 118 to the controller 110. The reading unit 118 reads an image on a document and converts the image into image data such as binary data. Further, the CPU 111 encrypts the image data generated by the reading unit 118 and performs an image process in accordance with settings in reading. The image data generated through various processes is transmitted to the information processing apparatus 200, stored in an external storage unit 122 connected to an external-storage I/F 121 from the outside of the image forming apparatus 100, or printed on a recording sheet by the printing unit 120. Further, state information about the reading unit 118 including a reading operation status and error information is stored in the RAM 113 and is given to the CPU 111.

The printing-unit I/F 119 connects the printing unit 120 to the controller 110. The CPU 111 transmits the image data to be printed (image data of a print target) to the printing unit 120 via the printing-unit I/F 119. The printing unit 120 prints an image on a recording sheet fed from a sheet feeding cassette (not illustrated). Further, the state information about the printing unit 120 including the operation status of printing and the error information is stored in the RAM 113 and is given to the CPU 111.

The external-storage I/F 121 connects the external storage unit 122 to the controller 110. The CPU 111 stores the image data to the external storage unit 122 via the external-storage I/F 121.

In the present embodiment, a USB interface is assumed as the external-storage I/F 121, and a USB memory is assumed as the external storage unit 122. However, the present disclosure is not limited to these as long as image data can be stored in an external storage unit such as connectable from the outside of the image forming apparatus 100 via the external-storage I/F 121. For example, an SD card may be used as the external storage unit 122.

The controller 110 is connected to the communication network 300 via the communication-unit I/F 123. The communication-unit I/F 123 can transmit the various information inside the image forming apparatus 100 towards the information processing apparatus 200. Here, the various information inside the image forming apparatus 100 includes various setting information about the operation of the image forming apparatus 100, the number of print pages by the image forming apparatus 100, use status information including error information, and the like.

The communication-unit I/F 123 receives a reference request for the various information inside the image forming apparatus 100 or a change request for the setting information from the information processing apparatus 200, reads the various information from the storage unit 114, or changes the setting information.

Further, a Web server application, which processes the HTTP, transmits the various information to the information processing apparatus 200 and receives the request for changing the contract information and setting information from the information processing apparatus 200 via the communication-unit I/F 123.

FIG. 3 is a block diagram illustrating a hardware configuration of the information processing apparatus 200. The information processing apparatus 200 includes various hardware components, such as a CPU 201, a ROM 202, a RAM 203, a storage unit 204, an operation-unit I/F 205, a display-unit I/F 207, and a communication-unit I/F 209. These components are communicably connected to each other via a bus. The operation unit 206 and the display unit 208 are externally connected to the information processing apparatus 200.

The CPU 201 achieves functions of the information processing apparatus 200 by controlling the various hardware components of the information processing apparatus 200. The CPU 201 also controls the operation of the information processing apparatus 200 according to a control program stored in the ROM 202. More specifically, the CPU 201 executes an OS that controls the information processing apparatus 200. Then, external application programs are additionally installed on the OS to add functions to the image forming apparatus 100. These programs operate mutually, and thereby, the operation and control of a function desired by the user are performed. The OS and the various programs are stored in the ROM 202, are read to the RAM 203, and are executed.

The ROM 202 is a memory to store the programs and various data used by the CPU 201. The RAM 203 is a work memory to temporarily store the programs and the data used for an arithmetic by the CPU 201.

The storage unit 204 is a storage device that stores various data, various programs, and the like. In the present embodiment, the storage unit 204 is assumed to be a hard disk, but may be another nonvolatile storage device such as an SSD.

The operation-unit I/F 205 is an interface that connects the operation unit 206 including a keyboard and a mouse to the information processing apparatus 200. The display-unit I/F 207 is an interface that connects the display unit 208 such as a liquid crystal display to the information processing apparatus 200.

The communication-unit I/F 209 is, for example, a network I/F to perform wired LAN (Local Area Network) communication. The communication unit I/F 209 is not limited to the configuration of the present embodiment as long as it is an interface capable of communicating with the image forming apparatus 100 through the Internet connection, and may be, for example, a network I/F for performing wireless LAN communication, a USB I/F, or the like.

In the present embodiment, because the information processing apparatus 200 is assumed to be a personal computer, the operation unit 206 and the display unit 208 are not included in the information processing apparatus 200, but this is not limited. For example, if the information processing apparatus 200 is a smartphone, the operation unit 206 and the display unit 208 are included in the information processing apparatus 200, and the present disclosure is applicable even in such a case.

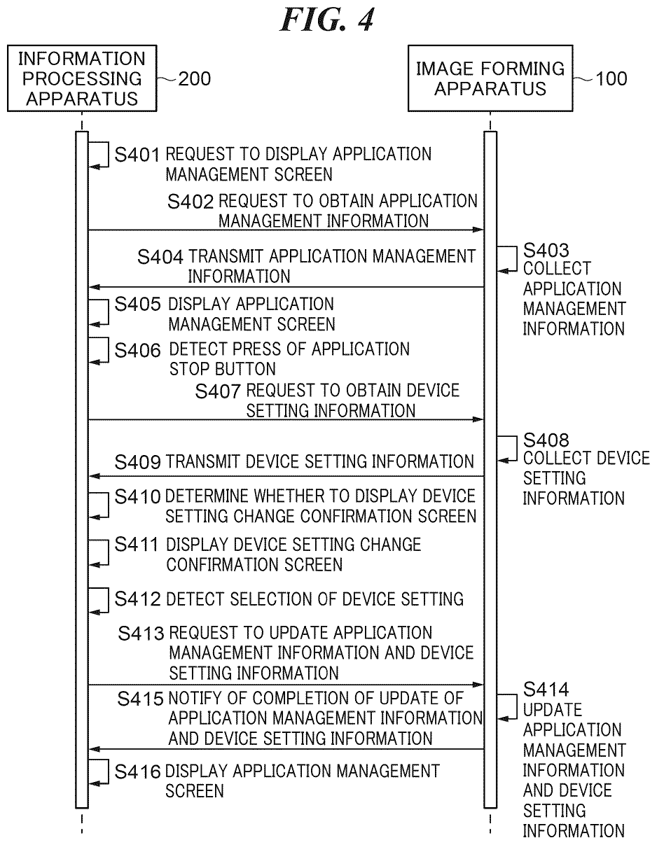

FIG. 4 is a sequence chart illustrating a sequence of the control process executed when an application pause button is pressed according to the present embodiment.

In FIG. 4, a case where the screen of the application that is temporarily stopped by a user has been registered as the “screen setting displayed on activation/resume” in advance will be described. Note that the “screen setting displayed on activation/resume” is a setting to display a screen of a function that is frequently used by a user at a time of activation (at a time of power on) and at a time of resume from a power saving state. In this case, in this sequence, a screen for prompting the user to change the “screen setting displayed on activation/resume” is displayed, and the setting change by the user is received. In the present embodiment, the user accesses a portal site that allows the user to browse and change the device setting of the image forming apparatus 100 and the information about the installed application by using the information processing apparatus 200, and performs an operation of temporarily stopping the application.

The following cases are exemplified as use cases in which the user wants to stop the application. A first use case is a case where failure of an IC card reader (not illustrated in FIG. 2) connected to the image forming apparatus 100 occurs when an application that performs an authentication process with an IC card is installed in the image forming apparatus 100. A second use case is a case where failure occurs in a vein authentication device (not illustrated in FIG. 2) connected to the image forming apparatus 100 when an application that performs an authentication process using a finger vein is installed in the image forming apparatus 100. A third use case is a case where a security hole of an application is discovered. A fourth use case is a case where the expiration of subscription managed by the application occurs when the application that manages the subscription is installed in the image forming apparatus 100.

First, the CPU 201 of the information processing apparatus 200 waits until the user accesses the portal site of the image forming apparatus 100 and presses a display request button (not illustrated) on an application management screen 600 described later using the display unit 208 (a step S401). Thereafter, when the CPU 201 detects that the display request button on the application management screen 600 is pressed, the process proceeds to a step S402. When the user wants to stop the application, the user accesses the portal site of the image forming apparatus 100 and requests the image forming apparatus 100 to display the application management screen 600 (described below) in the present embodiment. However, this is not limited. For example, the CPU 201 of the information processing apparatus 200 may detect occurrence or discovery of any of the use cases in which the user wants to stop the application. In this case, when the occurrence or discovery of any of the use cases is detected, a warning screen (an inquiring method) including a message indicating a content of the detection and a display request button to inquire of the user whether the application management screen 600 needs to be displayed may be displayed on the display unit 208.

When receiving the pressing of the button by the user detected in the step S401, the CPU 201 of the information processing apparatus 200 transmits an application management information obtaining request to the image forming apparatus 100 in the step S402.

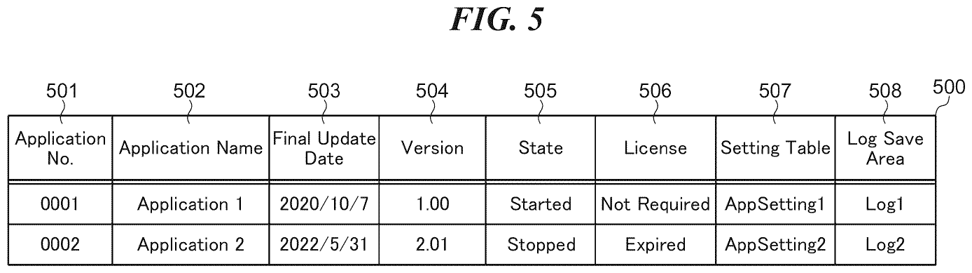

When receiving the application management information obtaining request from the information processing apparatus 200, the CPU 111 of the image forming apparatus 100 proceeds with the process to a step S403 and collects application management information 500 (FIG. 5) stored in the storage unit 114 (a first management unit).

FIG. 5 is a table illustrating an example of the application management information 500 used in the present embodiment. The application management information 500 includes an application number 501, an application name 502, an application final update date 503, an application version 504, an application state 505, a license 506, an application setting table 507, and a log save area 508.

The application number 501 shows a number and an ID for managing an application. The application name 502 shows a name of an application. Although a predetermined name is assigned to an application in the present embodiment, the user may be allowed to change a name of an application on the application management screen 600.

The application final update date 503 shows the last update date of an application. The date when the application was last updated (upgraded) is recorded here. In a case where the application has not been updated even once after the application is installed in the image forming apparatus 100, the installation date is recorded.

The application version 504 shows version information about an application. When the application is updated, the application version 504 is also updated. For example, the application of the application number 0001 has an application version of 1.00, and thus it is understood that the application has never been updated after installation.

The application state 505 indicates a current state of an application and has one of states of “Installed”, “Started”, and “Stopped”. In the present embodiment, management information about an uninstalled application is deleted and is not held. Therefore, the application does not have a state of “Uninstalled”, but may have the state of “Uninstalled” when all histories of installed applications are managed. The license 506 describes information related to a license for using an application. In the present embodiment, the information stored in the license 506 is any one of “Not Required”, “YYYY/MM/DD”, “Expired”, and “Always valid”. The state of “Not required” indicates that the application can be used without the license. If the license has an expiration date and can be used, the date and time of the expiration date is stored as “YYYY/MM/DD”. Else if the expiration date has expired, “Expired” is stored. If the license has no expiration date and can be used permanently once it is purchased, the license is stored as “Always Valid”.

In the present embodiment, the application setting table 507 stores address information about a management table (not illustrated) storing setting information about an application. When the application management information obtaining request is received in the step S403, the CPU 111 also collects information about an application setting information management table (not illustrated) at an address stored in the application setting table 507. Examples of the application setting information include a setting indicating whether an application is also activated on activation of the image forming apparatus 100, and various setting information on execution of copying set by the user for a copying application.

In the present embodiment, the log save area 508 stores address information at which an operation log of an application is stored. When the application management information obtaining request is received in the step S403, the CPU 111 also collects the operation log information about the application at the address stored in the log save area 508. Because the operation log information has a large size, the operation log information may not be obtained when the application management information obtaining request is received in the step S403, and the log information obtaining request may be separately transmitted by an operation on the application management screen 600.

Returning to the description of FIG. 4. When the collection of the application management information 500 is completed, the CPU 111 proceeds with the process to a step S404 and transmits the application management information 500 to the information processing apparatus 200. When receiving the application management information 500 from the image forming apparatus 100, the CPU 201 of the information processing apparatus 200 proceeds with the process to a step S405 and displays the application management screen 600 on the display unit 208.

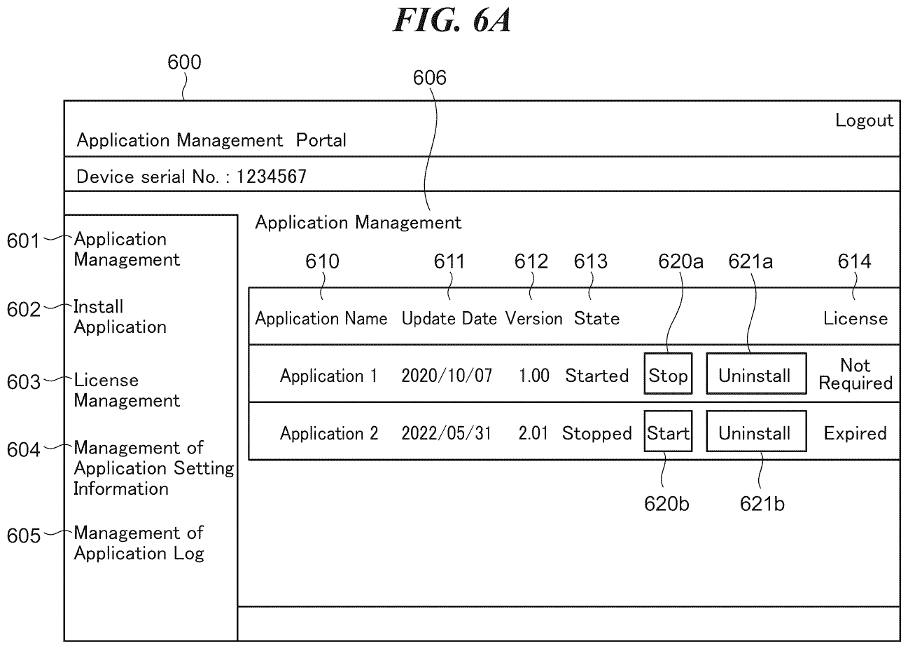

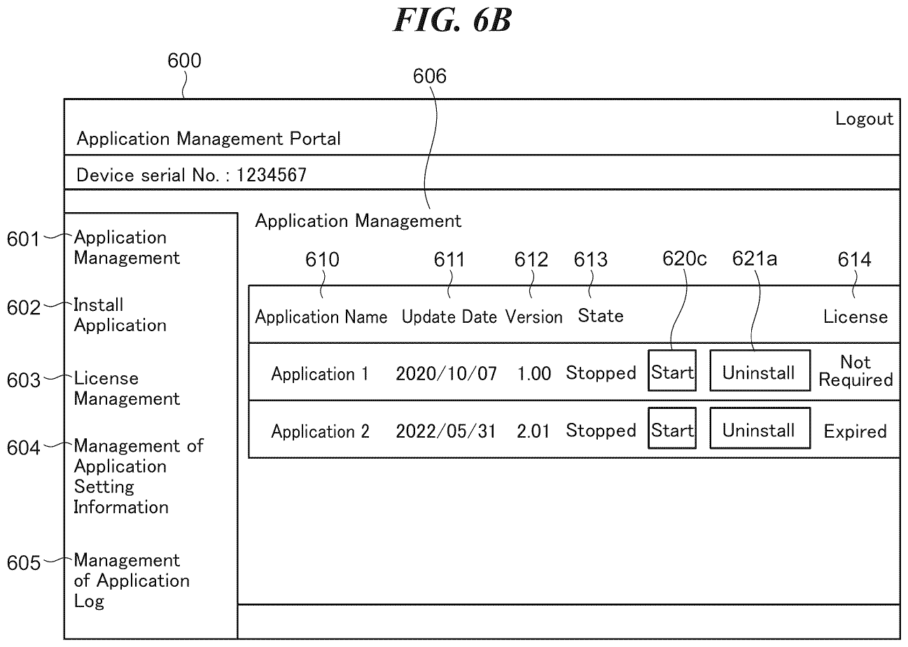

FIG. 6A and FIG. 6B are views illustrating examples of the application management screens 600 displayed on the display unit 208. As illustrated in FIG. 6A and FIG. 6B, the application management screen 600 (a first UI) includes items 601 to 605 and an information display area 606.

The items 601 to 605 are used for displaying an application management screen, an application installation screen, a license management screen, an application setting information management screen, and an application log management screen, respectively. The names of the screens corresponding to the respective items are displayed as the items 601 to 605. When the user selects any one of the items 601 to 605, a screen corresponding to the selected item is displayed in the information display area 606. FIG. 6A and FIG. 6B show examples in which the user selects the item 601 and the application management screen is displayed in the information display area 606.

The application management screen includes an application name 610, an update date 611, a version 612, a state 613, a license 614, state change buttons 620a and 620b, and uninstall buttons 621a and 621b.

The application name 610 displays the application name 502 (FIG. 5). The update date 611 displays the final update date 503 (FIG. 5) of the application. The version 612 displays the application version 504 (FIG. 5). The state 613 displays the application state 505 (FIG. 5). The license 614 displays the license 506 (FIG. 5).

The state change buttons 620a and 620b (a stop button and a start button) are buttons for the user to instruct the state change of each of the “Application 1” and “Application 2”. In the example in FIG. 6A, because the application 1 (a first application) is in the started state, the state change button 620a is displayed as “Stop”. Therefore, when the user presses the state change button 620a, the CPU 201 receives an intention (a stop instruction) to stop the “Application 1” from the user. Similarly, because the “Application 2” (a second application) is in the stopped state, the state change button 620b is displayed as “Start”. Therefore, when the user presses the state change button 620b, the CPU 201 receives an intention (a start instruction) to start the “Application 2” from the user.

The uninstall button 621a and 621b are buttons for the user to instruct the uninstallation of the “Application 1” and “Application 2”. For example, when the user presses the uninstall button 621a, the CPU 201 receives an intention (an uninstall instruction) to uninstall the “Application 1” from the user.

When the user selects the item 602, an application installation screen is displayed in the information display area 606. Accordingly, the user can instruct the installation of a desired application, which is selected from a list of applications that are included in the application installation screen and can be installed in the image forming apparatus 100, into the image forming apparatus 100.

When the user selects the item 603, a license management screen is displayed in the information display area 606. Accordingly, the user can confirm a license purchase status and expiration date included in the license management screen, and can additionally purchase the license by pressing an additional license purchase button on the same screen.

When the user selects the item 604, an application setting information management screen is displayed in the information display area 606. Accordingly, the user can instruct to change a desired setting selected from a list of application settings on the application setting information management screen.

When the user selects the item 605, an application log management screen is displayed in the information display area 606. Accordingly, the user can check the log of the application by selecting desired log information from a list of pieces of log information respectively associated with applications installed in the image forming apparatus 100 on the application log management screen.

Note that a detailed description using a screen example of each screen displayed when the user selects each of the items 602 to 605 will be omitted.

Returning to the description of FIG. 4. When the CPU 201 of the information processing apparatus 200 detects in a step S406 that the user operates the operation unit 206 and presses the state change button 620a on the application management screen 600, the process proceeds to a step S407. Here, a case where the user instructs to change the state of the “Application 1” by pressing the state change button 620a of the “Application 1” will be described, but the user may instruct to change the state of another application. For example, a case where pressing of the state change button 620b of the “Application 2” is detected may be considered. Although not illustrated in FIG. 6A and FIG. 6B, the same process is executed even when the CPU 201 detects pressing of the uninstall button 621a or 621b in the step S406.

In the step S407, when the CPU 201 of the information processing apparatus 200 detects that the user presses the state change button 620a of the “Application 1”, the information processing apparatus 200 transmits a device setting information obtaining request to the image forming apparatus 100.

In a step S408, when receiving the device setting information obtaining request from the information processing apparatus 200, the CPU 111 of the image forming apparatus 100 collects device setting information 900 stored in the storage unit 114 (a second management unit). Although only the “screen setting displayed on activation/resume” shall be obtained from the device setting information 900 in the present embodiment, the entire device setting information 900 may be collectively obtained.

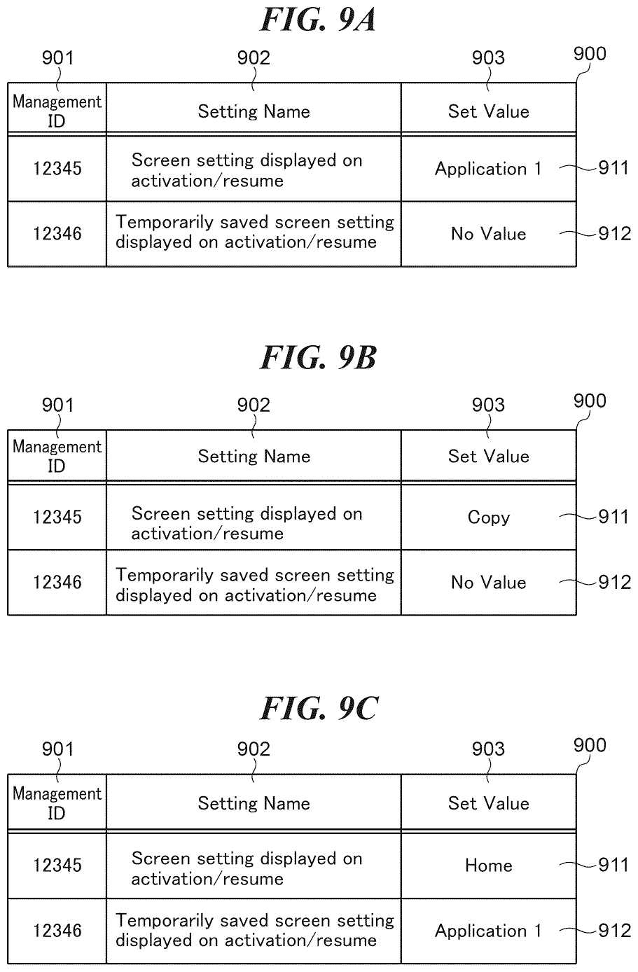

FIG. 9A, FIG. 9B, and FIG. 9C illustrate examples of the device setting information 900 according to the present embodiment. FIG. 9A and FIG. 9B indicate the device setting information for the present embodiment. On the other hand, FIG. 9C is the device setting information for a second embodiment and thus will be described in the second embodiment.

As illustrated in FIG. 9A, the device setting information 900 includes a management ID 901, a setting name 902, and a set value 903. In the example of FIG. 9A, the setting name 902 in the first row is set to “screen setting displayed on activation/resume”, and the set value 911 is set to “Application 1”. In FIG. 9A, the setting name 902 in the second row is set to “screen setting displayed on activation/resume (temporary save)”, and the set value 911 is set to “no value”. Because this setting will be described in the second embodiment, “no value” is set in this embodiment. Further, although not shown in FIG. 9A, FIG. 9B, and FIG. 9C, there are other device settings that can be set as the setting name 902 in addition to the “screen setting displayed on activation/resume” and the “screen setting displayed on activation/resume (temporary save)”.

Returning to FIG. 4, when the device setting information 900 has been collected in the step S408, the CPU 111 transmits the device setting information 900 to the information processing apparatus 200 in a step S409.

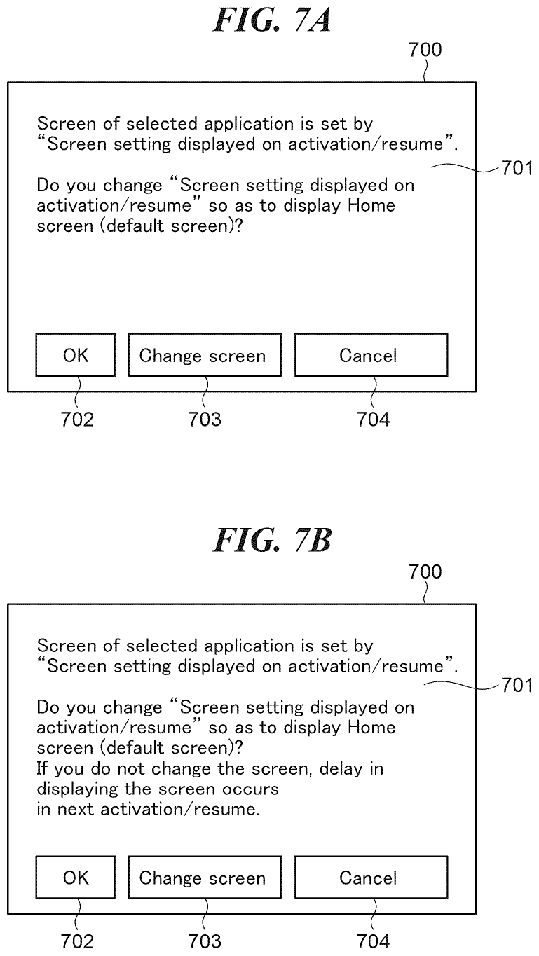

When receiving the device setting information 900 from the image forming apparatus 100, the CPU 201 of the information processing apparatus 200 proceeds with the process to a step S410 and determines whether to display a device setting change confirmation screen 700 (FIG. 7A). Specifically, it is confirmed whether the screen of the application (Application 1) that the user instructs to stop by pressing the state change button 620a is set as the “screen setting displayed on activation/resume”. For example, when the set value 911 corresponding to the setting name “screen setting displayed on activation/resume” is set to the “Application 1” as shown in the first row in FIG. 9A, the CPU 201 determines that the device setting change confirmation screen 700 needs to be displayed. Hereinafter, a case where it is determined that the device setting change confirmation screen 700 needs to be displayed in the step S410 and the process proceeds to a step S411 will be described.

As described above, the CPU 201 may detect that the user has instructed uninstall by pressing the uninstall button 621a or 621b in the step 406. In this case, it is confirmed whether the screen of the application for which user instructs uninstall is set as the “screen setting displayed on activation/resume” in the step S410. For example, when the user instructs to uninstall the “Application 2”, the “Application 2” is not registered in the device setting information 900 in FIG. 9A, and thus the screen of the “Application 2” is not set to the “screen setting displayed on activation/resume”. In this case, the CPU 201 proceeds with the process to a step S413. Note that, also in a case where it is determined that the device setting change confirmation screen 700 does not need to be displayed in the step S410, that is, the set value 911 of the application instructed to be stopped is not set to the “screen setting displayed on activation/resume”, the process similarly proceeds to the step S413.

In the step S411, the CPU 201 displays the device setting change confirmation screen 700 on the display unit 208.

FIG. 7A and FIG. 7B are views illustrating examples of the device setting change confirmation screen 700 according to the present embodiment.

The device setting change confirmation screen 700 (a second UI) includes a message display area 701, an OK button 702, a change screen button 703, and a cancel button 704.

The message display area 701 is an area for displaying a message to user. In the present embodiment, it is confirmed that the screen of the “Application 1” for which the user instructs to stop by pressing the state change button 620a in the step S410 is set as the “screen setting displayed on activation/resume”. Therefore, in the message display area 701, as shown in FIG. 7A, the message for calling attention of the user and prompting a setting change is displayed. If there is a problem such as a delay in screen display at the next activation when the user does not change the setting, this matter may be displayed in the message display area 701 as indicated in FIG. 7B.

The OK button 702 is a button for receiving an intention (a change instruction: a first instruction) that the user agrees with the message in the message display area 701. In the present embodiment, when the user presses the OK button 702, the CPU 201 determines that the user has selected the home screen (a default screen) as the “screen setting displayed on activation/resume”.

The cancel button 704 is a button for receiving an intention that the user does not agree with the message in the message display area 701. In this embodiment, when the user presses the cancel button 704, the CPU 201 determines that user has selected to leave the “screen setting displayed on activation/resume” as is.

The change screen button 703 is a button for receiving an intention (a change instruction: a second instruction) of setting a screen other than the Home screen (other than the default screen). In the present embodiment, when the user presses the change screen button 703, the CPU 201 displays a setting screen 800 for setting a screen displayed on activation/resume described later. The user can select and set the “screen setting displayed on activation/resume” using the setting screen 800 for setting a screen displayed on activation/resume.

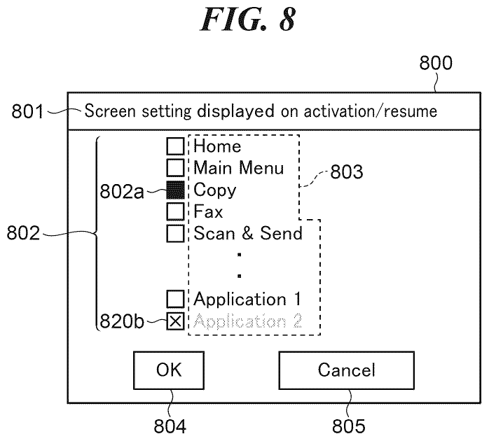

FIG. 8 is a view illustrating an example of the setting screen 800 for setting a screen displayed on activation/resume according to the present embodiment.

The setting screen 800 for setting a screen displayed on activation/resume (a third UI) includes a title display area 801, a checkbox group 802, a setting display area 803, an OK button 804, and a cancel button 805.

The title display area 801 is an area for displaying a title of the setting screen 800 for setting a screen displayed on activation/resume and is displayed as “Screen setting displayed on activation/resume” in the present embodiment.

The checkbox group 802 is used to receive an intention of the user to select a set value from among the plurality of set values displayed in the setting display area 803. In the present embodiment, the checkbox 802a corresponding to a copy screen in the checkbox group 802 is selected by a click operation by the user. The CPU 201 changes the checkbox 802a to black to indicate that the intention of the selection on the copy screen has been received. Note that the display change of the checkbox 802a is not limited to this as long as the display indicates that the intention of the selection from the user is received. For example, a check mark may be put in the checkbox 802a.

The setting display area 803 displays a plurality of set values indicating screens that can be set as the “screen setting displayed on activation/resume”. In the present embodiment, as indicated in FIG. 6A, the “Application 2”, which is one of the plurality of set values, is in the stopped state at the timing of this selection, and thus is displayed in the setting display area 803 in a grayed-out manner. A checkbox 802b corresponding to the “Application 2” is displayed but is controlled so that the user cannot select.

The OK button 804 is used to receive an intention to agree to the setting change to the setting selected by the user in the checkbox group 802. In this embodiment, when the user presses the OK button 804, the CPU 201 determines that the user has selected the copy screen as the “screen setting displayed on activation/resume” and closes the setting screen 800 for setting a screen displayed on activation/resume. When none of the user selectable checkboxes in the checkbox group 802 is selected, the OK button 804 is displayed in the grayed-out manner and controlled not to be pressed.

The cancel button 805 is used to receive an intention that the user does not select the setting change. In the present embodiment, when the user presses the cancel button 805, the CPU 201 leaves the screen setting displayed on activation/return as is, and closes the setting screen 800 for setting a screen displayed on activation/resume.

When the setting screen 800 for setting a screen displayed on activation/resume is closed, the CPU 201 returns the display to the device setting change confirmation screen 700.

In the step S410, when the “screen setting displayed on activation/resume” indicates the screen of the application instructed to be stopped, the device setting change confirmation screen 700 is displayed. However, this is not limited. For example, the CPU 201 may perform an automatic change process that automatically changes the screen displayed on activation/resume to the default screen (HOME screen) without displaying the device setting change confirmation screen 700. In this automatic change process, the same operation and setting change process as when the user presses the OK button 702 on the device setting change confirmation screen 700 are performed.

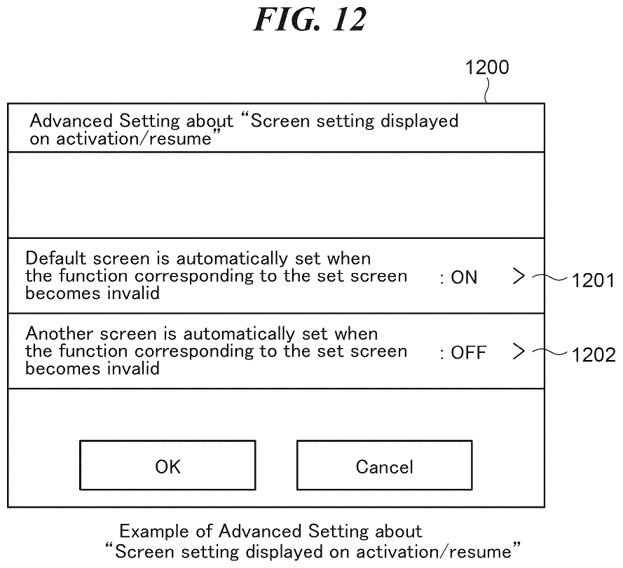

When an application is stopped or uninstalled, the function of the application is disabled. Therefore, an advanced setting screen 1200 about the “screen setting displayed on activation/resume” shown in FIG. 12 may be separately provided, and the automatic change process may be performed in the step S410 according to a content set in advance on this screen.

Here, the advanced setting screen 1200 (a fourth UI) about the “screen setting displayed on activation/resume” in FIG. 12 is configured from items 1201 and 1202 that can be switched between ON and OFF by the user.

The item 1201 (a first automatic change instruction) is used to switch ON and OFF of a setting in which “a default screen is automatically set when the function corresponding to the set screen becomes invalid”.

The item 1202 (a second automatic change instruction) is used to switch ON and OFF of a setting in which “another screen is automatically set when the function corresponding to the set screen becomes invalid”.

Therefore, when the item 1201 is ON and the item 1202 is OFF at the time of the process in the step S410, the CPU 201 performs the automatic change process.

On the other hand, when the item 1201 is OFF and the item 1202 is ON at the time of the process in the step S410, the automatic change process is not performed, but the CPU 201 displays the setting screen 800 for setting a screen displayed on activation/resume (a fifth UI) and prompts the user to select.

Returning to the description of FIG. 4. In a step S412, the CPU 201 of the information processing apparatus 200 detects what kind of device setting is selected using the device setting change confirmation screen 700 and the setting screen 800 for setting a screen displayed on activation/resume. Here, the selection of the device setting means how the user selects to set the “screen setting displayed on activation/resume”. After this detection, the process proceeds to the step S413. Here, in the present embodiment, an example of a case where the CPU 201 detects that the user selects to set the “screen setting displayed on activation/resume” to the copy screen in the step S412 will be described. That is, in the present embodiment, the user first shall press the change screen button 703 on the device setting change confirmation screen 700. Next, the user shall press the OK button 804 in a state where the checkbox 802a on the setting screen 800 for setting a screen displayed on activation/resume is selected as shown in FIG. 8.

Returning to FIG. 4, in the step S413, the CPU 201 requests the image forming apparatus 100 to update the application management information about the “Application 1”. Here, in the step S412, when the user selects the setting change (when the user selects the OK button 702 or 804), the CPU 201 (a change unit) also requests to update the “screen setting displayed on activation/resume”.

When receiving the update request of the step S413 from the information processing apparatus 200, the CPU 111 of the image forming apparatus 100 proceeds with the process to a step S414 and updates the application management information and device setting information stored in the storage unit 114. Specifically, the application state 505 of the “Application 1” in the application management information 500 is changed from “Started” to “Stopped”, and the operation of the “Application 1” is stopped. In addition, when the update request in the step S413 includes the update request for the “screen setting displayed on activation/resume”, the set value 911 (FIG. 9A) of the “screen setting displayed on activation/resume” is updated. In the present embodiment, the set value 911 of the “screen setting displayed on activation/resume” is updated from the “Application 1” indicated in FIG. 9A to the “Copy” indicated in FIG. 9B.

Returning to FIG. 4, when the update in the step S414 is completed, the CPU 111 proceeds with the process to a step S415 and notifies the information processing apparatus 200 of update completion.

When receiving the update completion notification in the step S415 from the image forming apparatus 100, the CPU 201 of the information processing apparatus 200 proceeds with the process to a S416 and updates the application management screen 600. Specifically, in the present embodiment, the state 613 of the “Application 1” is updated from “Started” indicated in FIG. 6A to “Stopped” indicated in FIG. 6B, and the state change button 620a is updated from “Stop” indicated in FIG. 6A to “Start” indicated as a state change button 620c in FIG. 6B and displayed. FIG. 6B shows an example of the application management screen 600 at this time. Thereafter, the present sequence is terminated.

In this way, when the user instructs the information processing apparatus 200 to temporarily stop or uninstall the application using the application management screen 600, the CPU 201 confirms whether the screen of the application is registered as the “screen setting displayed on activation/resume”. When it is registered, the CPU 201 displays a screen (FIG. 7A, FIG. 8) to prompt the user to change the “screen setting displayed on activation/resume”. Accordingly, it is possible to quickly display the screen on activation/resume without displaying a screen not desired by the user (that is, a screen of an application that the user instructs to temporarily step or uninstall).

Although the case of stopping the application has been described as an example in the present embodiment, the present disclosure is also applicable to a case where a screen of another disabled function of the image forming apparatus 100 is registered as the “screen setting displayed on activation/resume”. For example, it is assumed that the user can disable each of independent functions, such as copying, scanning, and faxing, included in the image forming apparatus 100 and the copy screen is set as the “screen setting displayed on activation/resume”. Under this situation, the present disclosure is also applicable to a case where the user instructs the image forming apparatus 100 to disable the copying function.

In addition, although the example in which the information processing apparatus 200 receives the stop instruction of the application by the user has been described in the present embodiment, the present disclosure can be achieved only by the image forming apparatus 100. In this case, an application management screen similar to the screen shown in FIG. 6A may be displayed on the operation unit 116 of the image forming apparatus 100, and a screen similar to the screen shown in FIG. 7A or FIG. 8 may be displayed on the operation unit 116 when an application stop instruction is issued, so that the user can select a setting change.

In addition, although the case where the image forming apparatus 100 manages the application management information and the device setting information has been described in the present embodiment, these pieces of information may be managed by the information processing apparatus 200, an external cloud server, or the like.

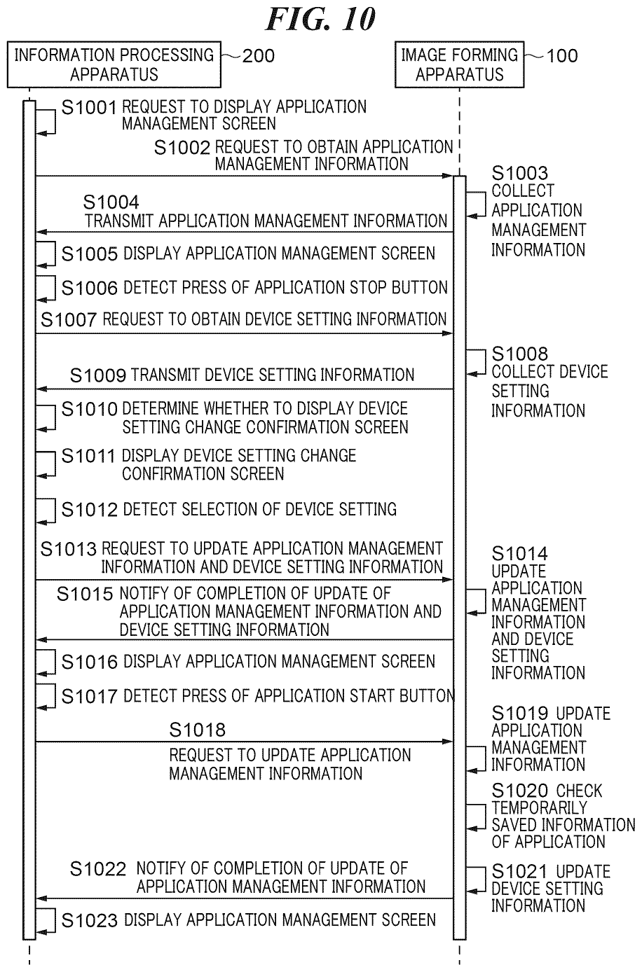

Next, the second embodiment will be described. In the first embodiment, when an application installed in the image forming apparatus 100 is temporarily stopped by the user operation and a screen of the application is registered as the “screen setting displayed on activation/resume”, the “screen setting displayed on activation/resume” is changed. However, when the application that has been temporarily stopped is restarted, it is desirable to return the screen of the application to the “screen setting displayed on activation/resume”. Therefore, in the present embodiment, when the application is temporarily stopped, the “screen setting displayed on activation/resume” is held as a temporary setting, and the setting can be returned to the held setting when the application is restarted. Hereinafter, the present embodiment will be described focusing on the difference from the first embodiment using FIG. 10. The same reference numerals are used for the same hardware components and software components as in the first embodiment, and duplicate descriptions will be omitted.

FIG. 10 is a sequence chart illustrating a sequence of a control process executed when an application pause button is pressed and when an application start button is pressed according to the present embodiment.

Because the process in steps S1001 to S1010 is the same as the process in the steps S401 to S410 in FIG. 4, the description thereof will be omitted. In the present embodiment, the case where the state change button 620a of the “Application 1” is pressed in the step S1006 is described as in the case of the step S406. In addition, in the present embodiment, the set value 911 of the “screen setting displayed on activation/resume” in the step S1008 is in the state shown in FIG. 9A similarly to the step S408. That is, the set value 911 is the “Application 1” as with the first embodiment.

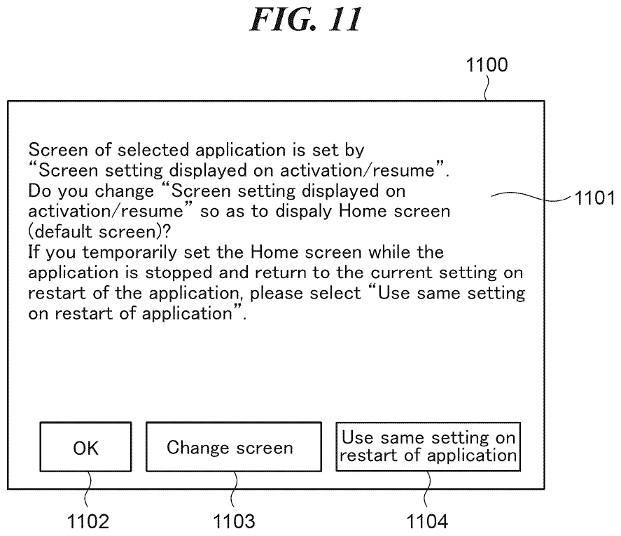

In the step S1010, the CPU 201 of the information processing apparatus 200 determines whether it is necessary to display a device setting change confirmation screen 1100 (FIG. 11). Although redundant description is omitted, when it is determined that it is necessary to display as in the step S410 in the first embodiment, the CPU 201 proceeds with the process to a step S1011 and displays the device setting change confirmation screen 1100 (FIG. 11) on the display unit 208. If it is determined that it is unnecessary to display the device setting change confirmation screen in the step S1010, that is, if the set value 911 of the “screen setting displayed on activation/resume” does not match the application instructed to be stopped, the process proceeds to a step S1013.

FIG. 11 is a view illustrating an example of the device setting change confirmation screen 1100 according to the present embodiment.

The device setting change confirmation screen 1100 includes a message display area 1101, an OK button 1102, a change screen button 1103, and a same setting button 1104.

In the message display area 1101, in addition to the message described in the message display area 701 in FIG. 7A, a description of the same setting button 1104 is also displayed as a message. In the message display area 1101, the message for the harmful effect may be displayed in the same manner as the message display area 701 shown in FIG. 7B of the first embodiment.

The OK button 1102 and the change screen button 1103 are the same as the OK button 702 and the change screen button 703 in FIG. 7A, and thus the descriptions thereof will be omitted. Further, the setting screen 800 for setting a screen displayed on activation/resume displayed when the change screen button 1103 is pressed is also similar to the description of FIG. 8 in the first embodiment, and thus a description thereof is omitted.

The same setting button 1104 is used to receive an intention (a change instruction: a third instruction) to temporarily set the Home screen while the application is stopped and return the setting to the current setting when the application is restarted. In the present embodiment, a case where the user presses the same setting button 1104 will be described. In this case, the CPU 201 determines that the user has selected the “Home” as the “screen setting displayed on activation/resume” and has selected the “Application 1” as the “temporarily saved screen setting displayed on activation/resume”.

When the user presses the change screen button 1103, selects the setting indicated in FIG. 8, and then presses the same setting button 1104, the setting indicated in FIG. 8 is not reflected in the present embodiment. However, it may be reflected. If it is reflected, the CPU 201 may determine that the user selects the “Copy” as the “screen setting displayed on activation/resume” and selects the “Application 1” as the “temporarily saved screen setting displayed on activation/resume”.

Returning to the description of FIG. 10. In a step S1012, the CPU 201 detects what kind of device setting has been selected by the user using the device setting change confirmation screen 700 and the setting screen 800 for setting a screen displayed on activation/resume. Here, the selection of the device setting means how the user selects to set the “screen setting displayed on activation/resume” or the “temporarily saved screen setting displayed on activation/resume”. After this detection, the process proceeds to the step S1013. In the present embodiment, a case where the CPU 201 determines that the user presses the same setting button 1104 in the step S1012 will be described.

Returning to FIG. 10, in the step S1013, the CPU 201 requests the image forming apparatus 100 to update the application management information and the device setting information about the “Application 1”. In the present embodiment, because the setting change of the “screen setting displayed on activation/resume” is always selected on the device setting change confirmation screen 1100, the update of the “screen setting displayed on activation/resume” is also requested. In addition, when the “temporarily saved screen setting displayed on activation/resume” needs to be changed, that is, when the same setting button 1104 is selected in the step S1012, the CPU 201 (a first controller) also requests to update the “temporarily saved screen setting displayed on activation/resume”.

When receiving the update request in the step S1013 from the information processing apparatus 200, the CPU 111 of the image forming apparatus 100 proceeds with the process to a step S1014 and updates the application management information and the device setting information stored in the storage unit 114. Specifically, the application state 505 of the “Application 1” in the application management information 500 is changed from “Started” to “Stopped”, and the operation of the “Application 1” is stopped. Further, because the update request in the step S1013 always includes the update request of the “screen setting displayed on activation/resume”, the set value 911 (FIG. 9A) of the “screen setting displayed on activation/resume” is updated. In the present embodiment, the set value 911 of the “screen setting displayed on activation/resume” is updated from the “Application 1” indicated in FIG. 9A to the “Home” indicated in FIG. 9C. Further, when the update request for the “temporarily saved screen setting displayed on activation/resume” is received, a set value 912 of the “temporarily saved screen setting displayed on activation/resume” is updated. In the present embodiment, the set value 912 of the “temporarily saved screen setting displayed on activation/resume” is updated to the “Application 1” as indicated in FIG. 9C.

Returning to FIG. 10, when the update in the step S1014 is completed, the CPU 111 proceeds with the process to a step S1015 and notifies the information processing apparatus 200 of update completion.

When receiving the update completion notification in the step S1015 from the image forming apparatus 100, the CPU 201 of the information processing apparatus 200 proceeds with the process to a step S1016 and updates the application management screen 600. Specifically, in the present embodiment, the state 613 of the “Application 1” is updated from “Started” indicated in FIG. 6A to “Stopped” indicated in FIG. 6B, and the state change button 620a is updated from “Stop” indicated in FIG. 6A to “Start” indicated as a state change button 620c in FIG. 6B and displayed. FIG. 6B shows an example of the application management screen 600 at this time.

Thereafter, in a step S1017, when detecting that the user operates the operation unit 206 and presses the state change button 620c of the “Application 1” on the application management screen 600 in FIG. 6B, the CPU 201 of the information processing apparatus 200 proceeds with the process to a step S1018. As shown in FIG. 6B, because “Start” is described in the state change button 620c, the CPU 201 determines that a start request of the “Application 1” by the user is detected here.

The CPU 201 of the information processing apparatus 200 receives the start request of the “Application 1” from the user determined by the detection in the step S1017 and requests the image forming apparatus 100 to update the application management information in the step S1018.

When receiving the update request from the information processing apparatus 200 in the step S1018, the CPU 111 of the image forming apparatus 100 proceeds with the process to a step S1019 and updates the application management information stored in the storage unit 114. Specifically, the application state 505 of the “Application 1” of the application management information 500 is updated from “Stopped” updated in the step S1016 to “Started”, and the operation of the “Application 1” in the image forming apparatus 100 is started (restarted).

Next, the CPU 111 proceeds with the process to a step S1020 and confirms the set value 912 of the “temporarily saved screen setting displayed on activation/resume” (temporarily saved information), and confirms whether the application matches the application requested to start from the user in the step S1017. In the present embodiment, the application requested to start in the step S1017 is the “Application 1” that matches the set value 912 of the “temporarily saved screen setting displayed on activation/resume” indicated in FIG. 9C. In this way, when the application requested to start matches the set value 912, the CPU 111 (a second control unit) determines that the set value is temporarily saved in stopping the “Application 1” and proceeds with the process to a step S1021 to update the related device setting information 900.

Specifically, in the present embodiment, the “Home” that is the set value 911 of the “screen setting displayed on activation/resume” is updated (reset) to the “Application 1” that is the set value 912 of the “temporarily saved screen setting displayed on activation/resume”. After the set value 911 of the “screen setting displayed on activation/resume” is updated, the “Application 1”, that is the set value 912 of the “temporarily saved screen setting displayed on activation/resume” is updated to “No Value”.

In this way, the set value (that is, the “Application 1”) temporarily saved in the “temporarily saved screen setting displayed on activation/resume” in the process in the steps S1012 to S1014 in stopping the application is written back to the “screen setting displayed on activation/resume” in restarting the application. As a result, the state shown in FIG. 9C can be returned to the state shown in FIG. 9A.

Although the “temporarily saved screen setting displayed on activation/resume” is described so as to hold the set value of only one application in this embodiment, set values of a plurality of installable applications may be held and managed.

On the other hand, as a result of the confirmation in the step S1020, when the application requested to start does not match the set value 912, which is different from the assumption in the present embodiment, the CPU 111 does nothing in the step S1021 and proceeds with the process to a step S1022 as is.

When the confirmation process in the step S1019 and the update process in the step S1019 (including the case of updating nothing) are completed, the CPU 111 proceeds with the process to a step S1022 and notifies the information processing apparatus 200 of the update completion.

When receiving the update completion notification in the step S1022 from the image forming apparatus 100, the CPU 201 of the information processing apparatus 200 proceeds with the process to a step S1023.

In the step S1023, the CPU 201 updates the application management screen 600 so as to update the state 613 of the “Application 1” to “Started” and update the state change button 620a to “Stop”, and displays the updated application management screen 600. The application management screen at this time is the same screen as FIG. 6A displayed in the step S1005. Thereafter, the present sequence is terminated.

With the above configuration, when the user temporarily stops application in the information processing apparatus 200 using the application management screen 600, the “screen setting displayed on activation/resume” is held, and the screen setting can be returned to the held screen setting when the application is restarted.

According to the present embodiment, when the application is temporarily stopped or uninstalled, the screen can be quickly displayed on activation/resume.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-010495, filed Jan. 24, 2025 which is hereby incorporated by reference herein in its entirety.

What is claimed is:

1. An image forming apparatus to which a function is added by additionally installing an external application, the image forming apparatus comprising:
a memory device that stores a set of instructions; and
at least one processor that executes the set of instructions to:
stop an operation of the external application in a case where the external application is in a started state and a stop instruction to stop the external application is received from a user; and
change a screen setting displayed on activation or resume from a power saving state in accordance with a change instruction from the user to change the screen setting displayed on the activation or the resume in a case where the stop instruction and the change instruction are received under a state where a screen setting of the external application is set as the screen setting displayed on the activation or the resume in device setting information about the image forming apparatus.

2. The image forming apparatus according to claim 1, wherein the change instruction is a first instruction to change the screen setting displayed on the activation or the resume from the screen setting of the external application to a default screen setting.

3. The image forming apparatus according to claim 1, wherein the change instruction is a second instruction to change the screen setting displayed on the activation or the resume from the screen setting of the external application to another screen setting other than a default screen setting.

4. The image forming apparatus according to claim 1, wherein the at least one processor that executes the set of instructions to change the screen setting displayed on the activation or the resume without receiving the change instruction when receiving the stop instruction in a case where the screen setting of the external application is set as the screen setting displayed on the activation or the resume under a state where a screen setting of a disabled function set as the screen setting displayed on the activation or the resume will be automatically changed.

5. The image forming apparatus according to claim 4, wherein the at least one processor that executes the set of instructions to receive a screen setting to be set by automatic change from the user in advance.

6. The image forming apparatus according to claim 5, wherein the at least one processor that executes the set of instructions to receive a first automatic change instruction from the user to set a default screen setting to be set by the automatic change.

7. The image forming apparatus according to claim 5, wherein the at least one processor that executes the set of instructions to:
receive a second automatic change instruction from the user to set another screen setting other than a default screen setting to be set by the automatic change; and
receive one screen setting selected from among a plurality of screen settings that can be set as the screen setting displayed on the activation or the resume in response to the second automatic change instruction.

8. The image forming apparatus according to claim 1, wherein a function of performing an authentication process using an IC card is added to the image forming apparatus by installing the external application,
wherein the at least one processor that executes the set of instructions to:
notify the user of a detected content when occurrence of failure of an IC card reader connected to the image forming apparatus is detected; and
inquire of the user whether to display information about the external application.

9. The image forming apparatus according to claim 1, wherein a function of performing an authentication process using a finger vein is added to the image forming apparatus by installing the external application,
wherein the at least one processor that executes the set of instructions to:
notify the user of a detected content when occurrence of failure of a vein authentication device connected to the image forming apparatus is detected; and
inquire of the user whether to display information about the external application.

10. The image forming apparatus according to claim 1, wherein the at least one processor that executes the set of instructions to:
notify the user of a detected content when a security hole of the external application is discovered; and
inquire of the user whether to display information about the external application.

11. The image forming apparatus according to claim 1, wherein a function of managing subscription is added to the image forming apparatus by installing the external application,
wherein the at least one processor that executes the set of instructions to:
notify the user of a detected content when occurrence of expiration of the subscription is detected; and
inquire of the user whether to display information about the external application.

12. The image forming apparatus according to claim 1, wherein a first application and a second application are installed in the image forming apparatus as the external applications,
wherein the change instruction is a third instruction that instructs to change the screen setting displayed on the activation or the resume from a screen setting of the first application to a default screen setting and instructs to set a current setting of the screen setting displayed on the activation or the resume again in restarting the first application stopped by the stop instruction,
wherein the at least one processor that executes the set of instructions to:
receive a start instruction to start the external application from the user in a case where the external application is in a stopped state;
start the first application in a case where the start instruction to start the first application is received from the user;
hold the current setting of the screen setting displayed on the activation or the resume as a temporary setting and set the screen setting displayed on the activation or the resume to the default screen setting in a case where the third instruction is received;
set the screen setting displayed on the activation or the resume to the temporary setting again in a case where the screen setting of the first application started by the start instruction is set as the temporary setting.

13. A control method for an image forming apparatus to which a function is added by additionally installing an external application, the control method comprising:
stopping an operation of the external application in a case where the external application is in a started state and a stop instruction to stop the external application is received from a user; and
changing a screen setting displayed on activation or resume from a power saving state in accordance with a change instruction from the user to change the screen setting displayed on the activation or the resume in a case where the stop instruction and the change instruction are received under a state where a screen setting of the external application is set as the screen setting displayed on the activation or the resume in device setting information about the image forming apparatus.

14. A non-transitory computer-readable storage medium storing a control program causing a computer to execute a control method for an image forming apparatus to which a function is added by additionally installing an external application, the control method comprising:
stopping an operation of the external application in a case where the external application is in a started state and a stop instruction to stop the external application is received from a user; and
changing a screen setting displayed on activation or resume from a power saving state in accordance with a change instruction from the user to change the screen setting displayed on the activation or the resume in a case where the stop instruction and the change instruction are received under a state where a screen setting of the external application is set as the screen setting displayed on the activation or the resume in device setting information about the image forming apparatus.
